(19) United States
(12) Patent Application Publication
(10) Pub. No.: US 2021/0183177 A1
(43) Pub. Date: Jun. 17, 2021

(54) METHOD AND APPARATUS FOR MODEL-BASED ANALYSIS

(71) Applicant: Robert Bosch GmbH, Stuttgart (DE)

(72) Inventors: Ahmad Adee, Rutesheim (DE); Roman Gansch, Renningen (DE); Peter Munk, Renningen (DE); Lydia Gauerhof, Sindelfingen (DE); Markus Schweizer, Vaihingen/Enz (DE)

(21) Appl. No.: 17/107,027

(22) Filed: Nov. 30, 2020

(30) Foreign Application Priority Data
Dec. 16, 2019 (DE) 102019219730.2

(51) Int. Cl. G07C 5/08; G05B 23/02; G05D 1/00

(52) U.S. Cl. CPC G07C 5/085; G05D 1/0055; G05B 23/0243

(57) ABSTRACT

A computer-implemented method for model-based analysis, in particular safety analysis, of a technical system, in particular of a control device for a semiautonomous or autonomous vehicle. The method includes: furnishing a model that characterizes the system; furnishing first information items that characterize dependences between different components and/or subsystems of the system; ascertaining at least one state that at least one component and/or subsystem of the system, and/or the system, can assume; ascertaining, in particular based on the first information items and/or on the at least one state, a method for describing a behavior of the system.

### CROSS REFERENCE

The present application claims the benefit under 35 U.S.C. § 119 of German Patent Application No. 102019219730.2 filed on Dec. 16, 2019, which is expressly incorporated herein by reference in its entirety.

### BACKGROUND INFORMATION

The present invention relates to a method for model-based analysis, in particular safety analysis, of a technical system.

The present invention further relates to an apparatus for model-based analysis, in particular safety analysis, of a technical system.

### SUMMARY

Preferred embodiments of the present invention include a method, in particular a computer-implemented method, for model-based analysis, in particular safety analysis, of a technical system, in particular of a control device for a semiautonomous or autonomous vehicle, having the following steps: furnishing a model that characterizes the system; furnishing first information items that characterize dependences between different components and/or subsystems of the system; ascertaining at least one state that at least one component and/or subsystem of the system, and/or the system, can assume; ascertaining, in particular based on the first information items and/or on the at least one state, a method for describing a behavior of the system.

In further preferred embodiments of the present invention, provision is made that a modeling tool and/or a description language, in particular a machine-readable description language, for example SysML, is used for the furnishing of a model. Preferably, the model can have one or several components or subsystems. Also preferably, the system, in particular an operating behavior of the system, can be characterized using the model and using the method for describing the behavior of the system.

In further preferred embodiments of the present invention, provision is made that the method for describing the behavior of the system encompasses at least one of the following elements: a) Dempster-Shafer theory (DST) (G. Shafer, “A Mathematical Theory of Evidence.” Princeton University Press, 1976, Vol. 42); b) Dezert-Smarandache theory (DSmT) (F. Smarandache and J. Dezert, “An introduction to DSm theory of plausible, paradoxist, uncertain, and imprecise reasoning for information fusion,” Octogon Mathematical Magazine, Vol. 15, No. 2, pp. 681-722, 2007); c) Transferable Belief Model (TBM) (P. Smets, “Belief functions: The disjunctive rule of combination and the generalized Bayesian theorem,” Int. J. Approx. Reasoning, Vol. 9, No. 1, pp. 1-35, 1993); d) Shenoy-Shafer architecture (Shenoy, P. P., Shafer, G., “Propagating belief functions with local computations,” IEEE Expert 1 (3), 43-52 (1986)); e) Cano framework or “subjective logic” (Jøsang, Audun, “Subjective Logic: A Formalism for Reasoning Under Uncertainty.” Springer Publishing Company, Inc., 2018).

In further preferred embodiments of the present invention, provision is made that the ascertaining of the at least one state encompasses: ascertaining several states that the at least one component and/or subsystem of the system can respectively assume. In further preferred embodiments, provision is made that the method for describing a behavior of the system is then ascertained in particular based on the first information items and/or on the several states.

In further preferred embodiments of the present invention, provision is made that the ascertaining of the at least one state encompasses: ascertaining one or several states that at least one component and/or the subsystem of the system can respectively assume.

In further preferred embodiments of the present invention, provision is made that preferably those states which exceed a predefinable first threshold value, for instance with regard to a probability of their occurrence, consequently in particular states that occur comparatively often, are ascertained.

In further preferred embodiments of the present invention, provision can be made that preferably those states which do not exceed the predefinable first threshold value with regard to a probability of their occurrence, consequently in particular states that occur comparatively seldom, are not ascertained or remain unconsidered.

In further preferred embodiments of the present invention, provision is made that the method further encompasses: ascertaining second information items that characterize an “exclusiveness” between at least two states, and/or an “exhaustiveness” (each possible state of the system, and its context, is defined).

In further preferred embodiments of the present invention, provision is made that the method further encompasses: ascertaining third information items that characterize a credibility and/or plausibility of at least one source associated with the at least one state. In further preferred embodiments of the present invention a sensitivity analysis can be performed, in particular in order to investigate and/or evaluate effects of various components and/or subsystems. In further preferred embodiments, a mass function of contributing functions toward the end nodes (e.g., back propagation and/or MC drop) can be investigated for the sensitivity analysis.

In further preferred embodiments of the present invention, provision is made that the method further encompasses: ascertaining fourth information items based on the method for describing the behavior of the system, the fourth information items characterizing at least one of the following elements: a) a probability that is associated with the at least one state; b) a degree of conviction that is associated with the at least one state.

In further preferred embodiments of the present invention, provision is made that the method further encompasses: assigning attributes with regard to at least one of the following elements: a) open world state space assumption); b) flexible world state space assumption. In accordance with further preferred embodiments, the “flexible world state space assumption” approach can provide, for instance, at least one (in particular, unknown or undefined) state that possibly characterizes several further unknown or undefined states (e.g., two known states for a camera classifier: “pedestrian” and “car”—what happens if the environment can furthermore also encompass even further states?).

In further preferred embodiments of the present invention, provision is made that the method further encompasses: modeling the technical system based on the ascertained method for describing the behavior of the system, the modeling encompassing in particular the use of at least one directed acyclic graph (DAG).

In further preferred embodiments of the present invention, the directed acyclic graph encompasses nodes and edges, at least one node (which in accordance with further preferred embodiments can also be referred to as an “actor”) characterizing or representing a component or a subsystem of the technical system (e.g., a control device for a (semi) autonomous vehicle). In accordance with further preferred embodiments, the node or actor can have an effect on a predefinable (final or concluding) event.

In further preferred embodiments of the present invention, a node can be divided into states, or one or several states can be assigned to the nodes, which states, in accordance with further preferred embodiments, for instance, characterize and/or represent the most probable states that the actor or node can assume.

In further preferred embodiments of the present invention, at least one state, preferably several or all states (in particular, of an actor), can be respectively characterized or represented by at least one numerical value. In further preferred embodiments, the at least one numerical value can be, for instance, a probability value, or can be a “belief mass function,” in particular in accordance with G. Shafer, “A Mathematical Theory of Evidence.” Princeton University Press, 1976, Vol. 42 (for instance, the belief mass function characterizes a value (between 0 and 1) that quantifies a confidence value, e.g., with regard to an expert or with regard to data of a state). In further preferred embodiments, at least one other conceptual abstraction can also be allocated to at least one of the states, in particular based on an uncertainty quantification theory that is used.

In further preferred embodiments of the present invention, states can be mutually exclusive, for example characterizing closed world assumptions (in particular a limited state space or limited set of states) or open world assumptions, in particular an unlimited set of states.

In further preferred embodiments of the present invention, edges of the DAG can characterize how a state propagates or develops to another actor (node) of the system. In further preferred embodiments, the edges of the DAG can have at least one variable assigned to them, for instance a (conditional) probability and/or a conditional belief function and/or at least one statistical function, such that in accordance with further preferred embodiments, values of the variable can be influenced or modified depending on data that, for instance, are obtained by way of simulations and/or field tests.

In further preferred embodiments of the present invention, provision is made that the method further encompasses: evaluating at least one predefinable event, in particular with regard to at least one predefinable attribute. The predefinable event can be, for example, a “top level event” (e.g., with regard to the DAG), for instance an error, a functional insufficiency, and/or any other undesired event whose occurrence or existence is preferably to be investigated.

In further preferred embodiments of the present invention, it is assumed that states characterized by the nodes are mutually exclusive; that the closed world assumption (CWA) is true; and that two nodes are connected by an edge that, for instance, can be characterized by a conditional belief function in accordance with Dempster-Shafer theory (DST) (see G. Shafer, A Mathematical Theory of Evidence. Princeton University Press, 1976, Vol. 42).

In further preferred embodiments of the present invention, it is assumed that states characterized by the nodes are not mutually exclusive; that the flexible world assumption is true; and that two nodes are connected by an edge that can be characterized, for instance, by DST, in particular DSmT (see above), or TBM.

On the basis of investigations by the inventors, in accordance with further preferred embodiments there exists, in particular regardless of whether or not the states characterized by the nodes are mutually exclusive, and in particular regardless of the underlying assumption with regard to the world, an uncertainty with regard to the statement of evidence sources regarding different states (e.g., “the weather is ‘sunny’ with a probability of 0.8”). In accordance with further preferred embodiments of the present invention, this statement can in particular, preferably only, be completely accepted when a one-hundred-percent conviction exists with regard to the evidence source (e.g., sensor of the control device). In further preferred embodiments of the present invention, the concept of “second-order probability” can be used, which concept, in accordance with further preferred embodiments, can be modeled, for instance, using methods such as, for instance, subjective logic in accordance with Jøsang, Audun, “Subjective Logic: A Formalism for Reasoning Under Uncertainty.” Springer Publishing Company, Inc., 2018.

Further preferred embodiments of the present invention relate to an apparatus for executing the method in accordance with the embodiments.

In further preferred embodiments of the present invention, provision is made that the apparatus has at least one computing device and/or at least one memory device, assigned in particular to the computing device, for example for at least temporary storage of a computer program and/or of data (e.g., data for executing the method in accordance with preferred embodiments), the computer program in particular being embodied for execution of one or several steps of the method in accordance with the embodiments.

In further preferred embodiments of the present invention, the computing device has at least one computing unit, the computing unit encompassing at least one of the following elements: a microprocessor, a microcontroller, a digital signal processor (DSP), a programmable logic module (e.g., field programmable gate array (FPGA)), at least one computing core. In further preferred embodiments, combinations thereof are also possible.

In further preferred embodiments of the present invention, the memory device encompasses at least one of the following elements: a volatile memory, in particular a working memory (RAM); a nonvolatile memory, in particular a flash EEPROM.

Further preferred embodiments of the present invention include a computer program (product) encompassing instructions that, upon execution of the computer program by a computer, for instance the aforementioned computing device or computing unit, cause the latter to execute the method in accordance with the embodiments.

Further preferred embodiments include a computer-readable memory medium encompassing instructions, in particular in the form of a computer program, which, upon execution by a computer, cause the latter to execute the method in accordance with the embodiments.

Further preferred embodiments of the present invention include a data carrier signal that characterizes and/or transfers the computer program in accordance with the embodiments. For example, the computing device can have an optional, preferably bidirectional, data interface for receiving the data carrier signal.

Further preferred embodiments of the present invention include a use of the method in accordance with the embodiments and/or of the apparatus in accordance with the embodiments and/or of the computer program in accordance with the embodiments and/or of the data carrier signal in accordance with the embodiments for at least one of the following elements: a) executing a sensitivity analysis; b) investigating a safety of the intended functionality (SOTIF), in particular in accordance with ISO/PAS 21448, in particular in accordance with ISO/PAS 21448:2019 (see also, for instance, https://www.iso.org/standard/70939.html); c) model-based analysis, in particular safety analysis, of at least a part of a semiautonomous or autonomous vehicle, in particular a semiautonomous or autonomous motor vehicle.

The features in accordance with preferred embodiments can be used, for instance, during development of a technical system, for instance at least part of a semiautonomous or autonomous vehicle or of a control device therefor, in particular in integrated form, e.g., as a software tool for a development process. The features in accordance with preferred embodiments simplifies a model-based analysis, in particular safety analysis, of safety-critical systems. Examples of such systems from the automotive sector are: a) (automated) emergency braking system (AEB); b) lane keeping assist (LKA); c) adaptive cruise control (ACC); d) lane changing assist (LCA); e) advanced driving assistance systems (ADAS).

The features in accordance with preferred embodiments can furthermore be advantageously used to investigate and/or evaluate a safety of the intended functionality (SOTIF), and is moreover also applicable to future systems, including systems for fully autonomous driving, or for investigation or evaluation thereof in particular with regard to functional safety.

Further features, potential applications, and advantages of the present invention are evident from the description below of exemplifying embodiments of the present invention which are depicted in the Figures. All features described or depicted in that context, individually or in any combination, constitute the subject matter of the invention, regardless of their respective presentation or depiction in the description or in the drawings.

### BRIEF DESCRIPTION OF THE DRAWINGS

FIG. 1 schematically depicts a simplified block diagram of a model in accordance with preferred embodiments of the present invention.

FIG. 2A schematically depicts a simplified flow chart of a method in accordance with further preferred embodiments of the present invention.

FIG. 2B schematically depicts a simplified flow chart of a method in accordance with further preferred embodiments of the present invention.

FIG. 2C schematically depicts a simplified flow chart of a method in accordance with further preferred embodiments of the present invention.

FIG. 3 schematically depicts a simplified block diagram of an apparatus in accordance with further preferred embodiments of the present invention.

FIG. 4 schematically depicts a simplified graph in accordance with further preferred embodiments of the present invention.

### DETAILED DESCRIPTION OF EXAMPLE EMBODIMENTS

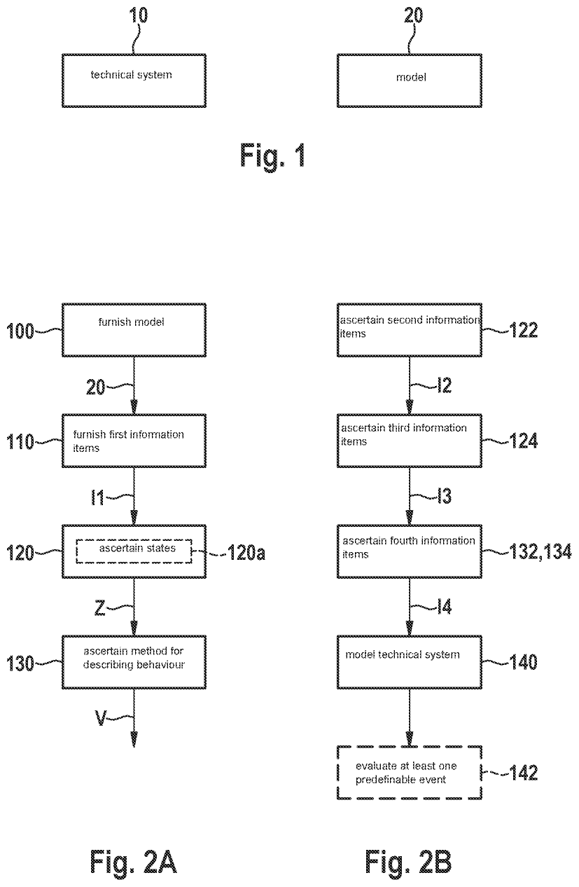

FIG. 1 schematically shows a simplified block diagram of a model 20 in accordance with preferred embodiments of the present invention. Model 20 characterizes a technical system 10 which can be, for instance, a control device for a semiautonomous or autonomous vehicle or a component of such a control device. In accordance with further preferred embodiments, model 20 can be used for analysis, in particular safety analysis (analysis with regard to functional safety aspects) of technical system 10.

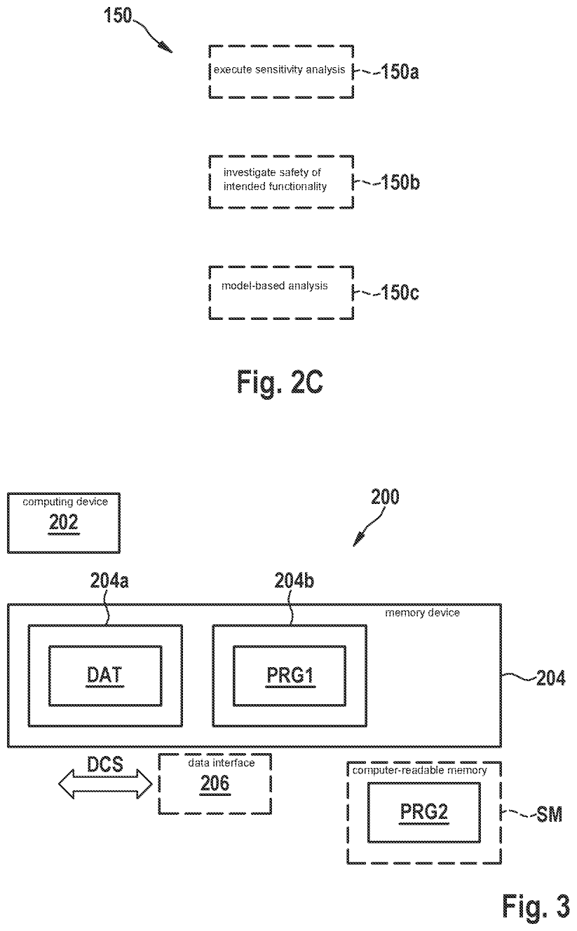

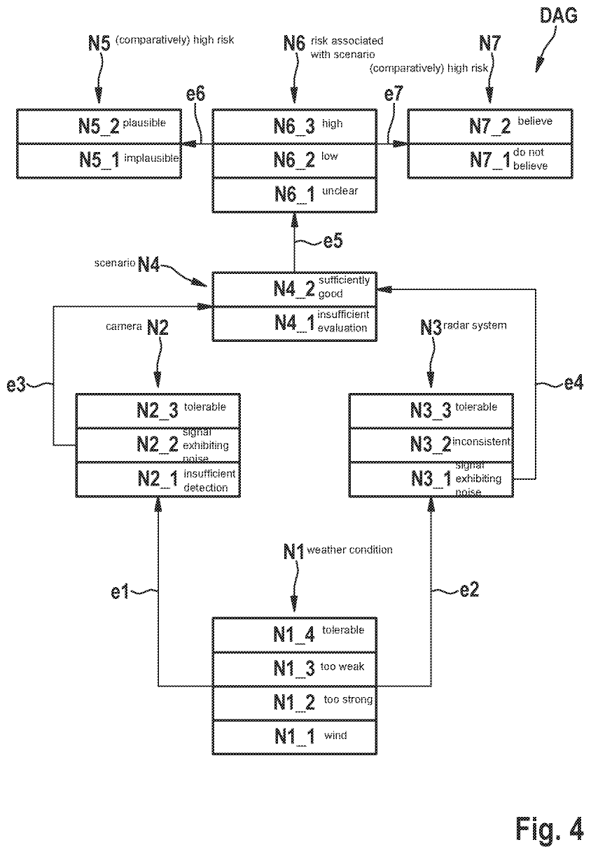

Further preferred embodiments (see FIG. 2A) of the present invention include a method, in particular a computer-implemented method, for model-based analysis, in particular safety analysis, of a technical system 10 (FIG. 1), having the following steps (FIG. 2A): furnishing 100 a model 20 (in particular on a system level) that characterizes system 10; furnishing 110 first information items I1 that characterize dependences between different components N1, N2, N3 (see FIG. 4) and/or subsystems of system 10 (FIG. 1) or of the corresponding model 20; ascertaining 120 at least one state Z that at least one component N1, N2, N3 and/or subsystem of system 10, and/or system 10, can assume; ascertaining 130, in particular based on first information items I1 and/or on the at least one state Z, a method V for describing a behavior of system 10.

In further preferred embodiments of the present invention, provision is made that a modeling tool and/or a description language, in particular a machine-readable description language, for example SysML, is used for the furnishing 100 of model 20.

In further preferred embodiments of the present invention, provision is made that method V for describing the behavior of system 10 encompasses at least one of the following elements: a) DST; b) Dezert-Smarandache theory (DSmT); c) Transferable Belief Model (TBM); d) Shenoy-Shafer architecture; e) Cano framework or “subjective logic.”

In further preferred embodiments of the present invention, provision is made that the ascertaining 120 of the at least one state Z encompasses: ascertaining 120a several states Z that the at least one component N1, N2, N3 (FIG. 4) and/or the subsystem of system 10 can respectively assume. In further preferred embodiments, provision is made that method V for describing the behavior of system 10 is then ascertained 130 in particular based on first information items I1 and/or on the several states Z.

In further preferred embodiments of the present invention, provision is made that the ascertaining 120 of the at least one state Z encompasses: ascertaining 120a one or several states Z that at least one component N1, N2, N3 and/or the subsystem of system 10 can respectively assume.

In further preferred embodiments of the present invention, provision is made that preferably those states Z which exceed a predefinable first threshold value, for instance with regard to a probability of their occurrence, consequently in particular states that occur comparatively often, are ascertained.

In further preferred embodiments of the present invention, provision can be made that preferably those states which do not exceed the predefinable first threshold value with regard to a probability of their occurrence, consequently in particular states that occur comparatively seldom, are not ascertained or remain unconsidered.

In further preferred embodiments of the present invention, provision is made that the method further encompasses (see FIG. 2B): ascertaining 122 second information items I2 that characterize an “exclusiveness” between at least two states, and/or an “exhaustiveness.”

In further preferred embodiments of the present invention, provision is made that the method further encompasses: ascertaining 124 third information items I3 that characterize a credibility and/or plausibility of at least one source associated with the at least one state Z.

In further preferred embodiments of the present invention, provision is made that the method further encompasses: ascertaining 132 fourth information items I4 based on method V for describing the behavior of system 10, fourth information items I4 characterizing at least one of the following elements: a) a probability that is associated with the at least one state; b) a degree of conviction that is associated with the at least one state.

In further preferred embodiments of the present invention, provision is made that the method further encompasses: allocating 134 attributes with regard to at least one of the following elements: a) open world state space assumption); b) flexible world state space assumption.

In further preferred embodiments of the present invention, provision is made that the method further encompasses: modeling 140 technical system 10 based on the ascertained method V (FIG. 2A) for describing the behavior of system 10, the modeling 140 encompassing in particular the use of at least one directed acyclic graph (DAG).

FIG. 4 shows for that purpose, by way of example, a directed acyclic graph (DAG) in accordance with further preferred embodiments of the present invention.

The directed acyclic graph encompasses nodes N1, N2, N3, N4, N5, N6, N7 and edges e1, e2, e3, e4, d5, e6, e7 that connect the nodes to one another, at least one node (which in accordance with further preferred embodiments can also be referred to as an “actor”) characterizing or representing a component or subsystem of technical system 10.

By way of example, node N1 according to FIG. 4 in the present case characterizes a weather condition, node N2 characterizes a camera, node N3 characterizes a radar system, node N4 characterizes a scenario, node N5 characterizes a (comparatively) high risk, node N6 characterizes a risk that in particular is associated with the scenario in accordance with node N4, and node N7 likewise characterizes a (comparatively) high risk.

In further preferred embodiments, at least one node or actor can have an effect on at least one other node or on a predefinable (final or concluding) event.

In further preferred embodiments, a node can be divided into states, or one or several states can be assigned to the node, which states, in accordance with further preferred embodiments, for instance, characterize and/or represent the most probable states that the actor or node can assume. By way of example, in FIG. 4 node N1 has assigned to it four states N1_1, N1_2, N1_3, N1_4 which are described in further detail below.

In further preferred embodiments, at least one state, preferably several or all states (in particular, of an actor), can be respectively characterized or represented by at least one numerical value. In further preferred embodiments, the at least one numerical value can be, for instance, a probability value, or can be a “belief mass function,” in particular in accordance with G. Shafer, “A Mathematical Theory of Evidence.” Princeton University Press, 1976, Vol. 42. In further preferred embodiments, at least one other conceptual abstraction can also be allocated to at least one of the states, in particular based on an uncertainty quantification theory that is used.

In further preferred embodiments, the value N1_1 characterizes, by way of example, “wind,” the value N1_2 characterizes a “too strong” statement, the value N1_3 characterizes a “too weak” statement, and the value N1_4 characterizes a tolerable range.

In further preferred embodiments, the value N2_1 characterizes, by way of example, an insufficient detection, the value N2_2 characterizes, by way of example, a signal exhibiting noise, and the value N2_3 characterizes, by way of example, a tolerable range.

In further preferred embodiments, the value N3_1 characterizes a signal exhibiting noise, the value N3_2 characterizes an inconsistent range, and the value N3_3 characterizes a tolerable range.

In further preferred embodiments, the value N4_1 characterizes an insufficient evaluation and the value N4_2 characterizes a sufficiently good evaluation.

In further preferred embodiments, the value N5_1 characterizes “implausible” and the value N5_2 characterizes “plausible.”

In further preferred embodiments, the value N6_1 characterizes “unclear,” the value N6_2 characterizes “low,” and the value N6_3 characterizes “high.”

In further preferred embodiments, the value N7_1 characterizes “do not believe” and the value N7_2 characterizes “believe.”

By way of the nodes N1 to N7 described by way of example above, and their states N1_1 to N7_2, the behavior of system 10 (FIG. 1) can thus be described, by way of example, in accordance with preferred embodiments.

In further preferred embodiments, states can be mutually exclusive, for example characterizing closed world assumptions or open world assumptions.

In further preferred embodiments, edges e1 to e7 of the DAG (FIG. 4) can characterize how a state propagates or develops to another actor (node) of the system. In further preferred embodiments, the edges of the DAG can have at least one variable assigned to them, for instance a (conditional) probability and/or a conditional belief function and/or at least one statistical function, such that in accordance with further preferred embodiments, values of the variable can be influenced or modified depending on data that, for instance, are obtained by way of simulations and/or field tests.

In further preferred embodiments of the present invention, provision is made that the method further encompasses (see FIG. 2B): evaluating 142 at least one predefinable event, in particular with regard to at least one predefinable attribute.

In further preferred embodiments, the method can be performed with an execution of steps 100, 110, 120, 122, 124, 130, 132, 140 described above.

In further preferred embodiments of the present inventin, it is assumed that states characterized by the nodes are mutually exclusive; that the closed world assumption (CWA) is true; and that two nodes are connected by an edge that, for instance, can be characterized by a conditional belief function in accordance with Dempster-Shafer theory (see reference above).

In further preferred embodiments of the present invention, it is assumed that states characterized by nodes N1 to N7 (FIG. 4) are not mutually exclusive; that the flexible world assumption is true; and that two nodes N1, N2 are connected by an edge e1 that can be characterized, for instance, by DST, in particular DSmT (see above) or TBM.

On the basis of investigations by the inventors, in accordance with further preferred embodiments, there exists, in particular regardless of whether or not the states characterized by the nodes are mutually exclusive, and in particular regardless of the underlying assumption with regard to the world, an uncertainty with regard to the statement of evidence sources regarding different states (e.g., “the weather is ‘sunny’ with a probability of 0.8”). In accordance with further preferred embodiments, this statement can in particular, preferably only, be completely accepted when an (in particular at least almost) one-hundred-percent conviction exists with regard to the evidence source (e.g., sensor of the control device). In further preferred embodiments, “second-order probability” can be used, which, in accordance with further preferred embodiments, can be modeled, for instance, using methods such as, for instance, subjective logic in accordance with Jøsang, Audun, “Subjective Logic: A Formalism for Reasoning Under Uncertainty.” Springer Publishing Company, Inc., 2018.

Further preferred embodiments refer to an apparatus 200 for executing the method in accordance with the embodiments (see FIG. 3).

In further preferred embodiments of the present invention, provision is made that apparatus 200 has at least one computing device 202 and/or at least one memory device 204, assigned in particular to computing device 202, for example for at least temporary storage of a computer program PRG1 and/or of data DAT (e.g., data for executing the method in accordance with preferred embodiments, for instance first information items I1 and/or second information items I2, etc.), computer program PRG1 in particular being embodied for execution of one or several steps of the method in accordance with the embodiments.

In further preferred embodiments of the present invention, apparatus 200 can, for example, also perform an execution of steps 100, 110, 120, 122, 124, 130, 132, 140.

In further preferred embodiments of the present invention, computing device 202 has at least one computing unit, the computing unit encompassing at least one of the following elements: a microprocessor, a microcontroller, a digital signal processor (DSP), a programmable logic module (e.g., field programmable gate array (FPGA)), at least one computing core. In further preferred embodiments, combinations thereof are also possible.

In further preferred embodiments of the present invention, memory device 204 encompasses at least one of the following elements: a volatile memory 204a, in particular a working memory (RAM); a nonvolatile memory 204b, in particular a flash EEPROM.

Further preferred embodiments of the present invention, include a computer program (product) PRG1, PRG2 encompassing instructions that, upon execution of computer program PRG1, PRG2 by a computer 202, for instance the aforementioned computing device 202 or computing unit, cause the latter to execute the method in accordance with the embodiments.

Further preferred embodiments of the present invention include a computer-readable memory medium SM encompassing instructions, in particular in the form of a computer program PRG2, that, upon execution by a computer 202, cause the latter to execute the method in accordance with the embodiments.

Further preferred embodiments of the present invention refer to a data carrier signal DCS that characterizes and/or transfers computer program PRG1, PRG2 in accordance with the embodiments. For example, computing device 202 can have an optional, preferably bidirectional, data interface 206 for receiving data carrier signal DCS.

Further preferred embodiments of the present invention include a use 150 (see FIG. 2C) of the method in accordance with the embodiments and/or of apparatus 200 in accordance with the embodiments and/or of computer program PRG1, PRG2 in accordance with the embodiments and/or of data carrier signal DCS in accordance with the embodiments for at least one of the following elements: a) executing 150a a sensitivity analysis; b) investigating 150b a safety of the intended functionality (SOTIF), in particular in accordance with ISO/PAS 21448, in particular in accordance with ISO/PAS 21448:2019 (see also, for instance, https://www.iso.org/standard/70939.html); c) model-based analysis 150c, in particular safety analysis, of at least a part 10 (FIG. 1) of a semiautonomous or autonomous vehicle, in particular a semiautonomous or autonomous motor vehicle.

The features in accordance with preferred embodiments of the present invention can be used, for instance, during development of a technical system 10, for instance at least part of a semiautonomous or autonomous vehicle or of a control device therefor, in particular in integrated form, e.g., as a software tool for a development process. The principle in accordance with preferred embodiments can simplify a model-based analysis, in particular safety analysis, of safety-critical systems. Examples of such systems from the automotive sector are: a) (automated) emergency braking system (AEB); b) lane keeping assist (LKA); c) adaptive cruise control (ACC); d) lane changing assist (LCA); e) advanced driving assistance systems (ADAS).

The features in accordance with preferred embodiments of the present invention can furthermore be advantageously used to investigate and/or evaluate a safety of the intended functionality (SOTIF), and is moreover also applicable to future systems, including systems for fully autonomous driving, or for investigation or evaluation thereof in particular with regard to functional safety.

With advances in the fields of technology, artificial intelligence (AI), and machine learning (ML), on the basis of investigations by the inventors more and more systems are being automated. Some of these systems are used, for example, in comparatively unstructured environments and are nevertheless, in particular, also critical with regard to functional safety, for instance in the field of automation technology, for example in the automotive industry. It can be difficult to evaluate the (in particular, functional) safety of such systems, for instance because an intended functionality of such systems can depend on, in some cases, highly complex algorithms, because sensors that are used have inherent limitations, and because a plurality of possible scenarios or environmental conditions are possible. On the basis of investigations by the inventors, these aspects can introduce uncertainty into a system.

The features in accordance with the embodiments makes possible efficient modeling of system 10 and, at least at times, efficient modeling of event propagation. In accordance with further embodiments, aspects of conditional belief functions, belief theory, and subjective logic are preferably utilized.

The features in accordance with the embodiments furthermore makes possible improved state space exhaustiveness, for instance, in accordance with further embodiments, by the fact that open world assumptions are used, or a flexible state space in which elements can be incorporated into or excluded from the state space.

In further preferred embodiments, the features in accordance with the embodiments can be used to ascertain or derive test cases, for instance using a sensitivity analysis with regard to at least one component (e.g., node N2 in accordance with FIG. 4) or one subsystem.

In further preferred embodiments of the present invention, important and/or high-risk test cases can be ascertained by way of the sensitivity analysis and, in accordance with further preferred embodiments, can be (further) investigated and/or tested and/or analyzed in the interest of increasing functional safety.

In further preferred embodiments of the present invention, the DAG (FIG. 4) can be used, in particular in combination with belief function theories such as DST, to recognize or ascertain unsafe and/or undesired states of a component or a function or a subsystem. In further preferred embodiments, such a recognition or ascertainment can also be performed in particular during a run time of a computer program or of system 10, with the result that the safety of components, or even of system 10, can also be increased, in particular, during the operation of system 10.

What is claimed is:

1. A computer-implemented method for model-based analysis of a technical system, comprising the following steps:
furnishing a model that characterizes the system;
furnishing first information items that characterize dependences between different components and/or subsystems of the system;
ascertaining at least one state that at least one component of the components and/or subsystem of the subsystems and/or the system, can assume;
ascertaining, based on the first information items and/or on the at least one state, a method for describing a behavior of the system.

2. The method as recited in claim 1, wherein the analysis is a safety analysis, and the technical system is a control device for a semiautonomous or autonomous vehicle.

3. The method as recited in claim 1, wherein the ascertaining of the at least one state includes: ascertaining several states that the at least one component and/or subsystem, can respectively assume.

4. The method as recited in claim 3, further comprising:
ascertaining second information items that characterize an exclusiveness between at least two states of the several states.

5. The method as recited in claim 1, further comprising:
ascertaining third information items that characterize a credibility and/or plausibility of at least one source associated with the at least one state.

6. The method as recited in claim 1, further comprising:
ascertaining fourth information items based on the method for describing the behavior of the system, the fourth information items characterizing at least one of the following elements: a) a probability that is associated with the at least one state, b) a degree of conviction that is associated with the at least one state.

7. The method as recited in claim 1, further comprising:
assigning attributes with regard to at least one of the following elements: a) open world state space assumption, b) flexible world state space assumption.

8. The method as recited in claim 1, further comprising:
modeling the technical system based on the ascertained method for describing the behavior of the system, the modeling encompassing using at least one directed acyclic graph.

9. The method as recited in claim 8, further comprising:
evaluating at least one predefinable event with regard to at least one predefinable attribute.

10. An apparatus, configured for model-based analysis of a technical system, the apparatus configured to:
furnish a model that characterizes the system;
furnish first information items that characterize dependences between different components and/or subsystems of the system;
ascertain at least one state that at least one component of the components and/or subsystem of the subsystems and/or the system, can assume;
ascertain, based on the first information items and/or on the at least one state, a method for describing a behavior of the system.

11. The apparatus as recited in claim 10, wherein the apparatus includes at least one of the following elements: a) a computing device, b) a memory device, c) a computer program.

12. A non-transitory computer-readable memory medium on which is stored instructions for model-based analysis of a technical system, the instructions, when executed by a computer, causing the computer to perform the following steps:
furnishing a model that characterizes the system;
furnishing first information items that characterize dependences between different components and/or subsystems of the system;
ascertaining at least one state that at least one component of the components and/or subsystem of the subsystems and/or the system, can assume;
ascertaining, based on the first information items and/or on the at least one state, a method for describing a behavior of the system.

13. The method as recited in claim 1, wherein the method is used for at least one of the following: a) executing a sensitivity analysis, b) investigating a safety of the intended functionality, c) model-based safety analysis of a semiautonomous or autonomous vehicle.
